(19) United States
(12) Patent Application Publication
(10) Pub. No.: US 2025/0153832 A1
(43) Pub. Date: May 15, 2025

(54) SHIP PROPULSION MACHINE

(71) Applicant: SUZUKI MOTOR CORPORATION, Hamamatsu-shi (JP)

(72) Inventors: Jun ITO, Hamamatsu-shi (JP); Shingo MATSUMOTO, Hamamatsu-shi (JP)

(73) Assignee: SUZUKI MOTOR CORPORATION, Hamamatsu-shi (JP)

(21) Appl. No.: 18/947,686

(22) Filed: Nov. 14, 2024

(30) Foreign Application Priority Data
Nov. 15, 2023 (JP) 2023-194307

(51) Int. Cl. B63H 20/28; B60L 15/00; B63H 20/00; B63H 20/14

(52) U.S. Cl. CPC B63H 20/285; B60L 15/007; B63H 20/14; B60L 2200/32; B63H 2020/003

(57) ABSTRACT

A ship propulsion machine includes: a first motor; a second motor, a first inverter configured; a second inverter; and a cooling mechanism. The cooling mechanism includes: a first motor water jacket; a second motor water jacket; a first inverter water jacket; and a second inverter water jacket. The first motor water jacket and the first inverter water jacket are connected in parallel with each other. The second motor water jacket is connected to a downstream side of the first motor water jacket, and the second inverter water jacket is connected to a downstream side of the first inverter water jacket.

### CROSS-REFERENCE TO RELATED APPLICATIONS

This application is based on and claims priority under 35 USC 119 from Japanese Patent Application No. 2023-194307 filed on Nov. 15, 2023, the contents of which are incorporated herein by reference.

### TECHNICAL FIELD

The present disclosure relates to a ship propulsion machine using a motor (electric motor) as a power source to propel a ship.

### BACKGROUND ART

JP2022-34677A describes an electric ship propulsion machine. In electric ship propulsion machines, an AC motor is often used as a power source to propel a ship. When an AC motor is used, an inverter is used to convert direct current from a battery into alternating current to drive the AC motor.

Motors and inverters generate heat during operation. In electric ship propulsion machines, a mechanism is provided to cool the motor and the inverter. For example, in a ship propulsion machine described in JP2022-34677A, a cooling water passage for allowing cooling water to flow is provided, a water jacket is provided in each of an inverter and a motor, a pump, the water jacket of the inverter, and the water jacket of the motor are connected in series to the cooling water passage, and a heat sink for cooling the cooling water flowing in the cooling water passage is attached to a portion of the cooling water passage.

### SUMMARY OF INVENTION

Incidentally, when the ship propulsion machine is provided with two motors and a propulsive force for a ship is generated by rotating a propeller with a force obtained by combining powers output from the two motors, an output of the ship propulsion machine can be increased. In addition, when the ship propulsion machine is provided with a power switching device that switches between a mode in which the propeller is rotated by a force obtained by combining powers of the two motors and a mode in which the propeller is rotated by power of one motor, it becomes easy to, for example, significantly increase or decrease the output of the ship propulsion machine or adjust the power consumption, thereby enhancing performance of the ship propulsion machine.

When the ship propulsion machine is provided with two motors, it is necessary to provide the ship propulsion machine with two inverters to drive the two motors, respectively, and also to provide a mechanism to cool the two motors and the two inverters respectively in the ship propulsion machine.

As a configuration of a mechanism to cool two motors and two inverters, respectively, a configuration is considered in which a configuration of a cooling mechanism provided in a ship propulsion machine described in JP2022-34677A is applied, a water jacket is provided in each of two motors and two inverters, and a total of four water jackets are connected in series to a cooling water passage.

However, when four water jackets are connected in series to the cooling water passage, cooling water will flow sequentially in the four water jackets. In this case, there is a concern that a cooling water flow path may become longer, resulting in increased pressure loss and reduced cooling efficiency.

In addition, when the water jacket for the motor and the water jacket for the inverter are connected in series to the cooling water passage, it is difficult to individually set a flow rate of cooling water flowing in the water jacket for the motor and a flow rate of cooling water flowing in the water jacket for the inverter, respectively, in response to the respective amounts of heat generation of the motor and the inverter. For this reason, it is difficult to individually optimize the cooling capacity for cooling the motor and the cooling capacity for cooling the inverter.

The present disclosure has been made in view of the problems as described above, for example, and an object of the present disclosure is to provide a ship propulsion machine that, when two motors and two inverters are provided, can enhance cooling efficiency for the two motors and two inverters and easily optimize the cooling capacity for cooling each of the two motors and two inverters in response to the respective amounts of heat generation of the two motors and the two inverters.

The present disclosure provides a ship propulsion machine including: a first motor; a second motor; a first inverter configured to generate a drive current for controlling drive of the first motor; a second inverter configured to generate a drive current for controlling drive of the second motor; a propeller; a power transmission mechanism configured to transmit power of each of the first motor and the second motor to the propeller; and a cooling mechanism configured to cool the first motor, the second motor, the first inverter, and the second inverter. The cooling mechanism includes: a first motor water jacket provided in the first motor and configured to cool the first motor by allowing cooling water to flow therein; a second motor water jacket provided in the second motor and configured to cool the second motor by allowing the cooling water to flow therein; a first inverter water jacket provided in the first inverter and configured to cool the first inverter by allowing the cooling water to flow therein; a second inverter water jacket provided in the second inverter and configured to cool the second inverter by allowing the cooling water to flow therein; a first cooling water passage configured to allow the cooling water to flow toward the first motor water jacket and the first inverter water jacket; a branch passage connecting the first motor water jacket and the first inverter water jacket to the first cooling water passage such that the first motor water jacket and the first inverter water jacket are connected in parallel with each other, the branch passage being configured to distribute and supply the cooling water flowing in the first cooling water passage to the first motor water jacket and the first inverter water jacket; a first connecting passage connecting the second motor water jacket to a downstream side of the first motor water jacket and configured to deliver the cooling water flowing in the first motor water jacket to the second motor water jacket; and a second connecting passage connecting the second inverter water jacket to a downstream side of the first inverter water jacket and configured to deliver the cooling water flowing in the first inverter water jacket to the second inverter water jacket.

According to the present disclosure, when two motors and two inverters are provided, it is possible to enhance cooling efficiency for the two motors and two inverters and easily optimize the cooling capacity for cooling each of the two motors and two inverters in response to the respective amounts of heat generation of the two motors and the two inverters.

### BRIEF DESCRIPTION OF DRAWINGS

The present disclosure will be described in detail based on the following without being limited thereto, wherein:

FIG. 1 is an explanatory view showing an outboard motor, which is an embodiment of a ship propulsion machine of the present disclosure;

FIG. 2 is a perspective view showing a first motor, a second motor, a first inverter, a second inverter, a motor holder, and the like in the outboard motor according to the embodiment of the present disclosure;

FIG. 3 is an explanatory view showing the first motor, the second motor, the first inverter, the second inverter, the motor holder, and the like in FIG. 2, as viewed from the left;

FIG. 4A is an explanatory view showing a state of the first motor, the second motor, the first inverter, the second inverter, the motor holder, and the like in FIG. 2, as viewed from behind, and FIG. 4B is an explanatory view showing a state of the first motor, the second motor, the first inverter, the second inverter, the motor holder, and the like in FIG. 2, as viewed from above;

FIG. 5A is a cross-sectional view taken along cutting line V-V in FIG. 3, showing a state of the first motor, the first inverter, and the like, as viewed from above, and FIG. 5B is an explanatory view showing a power switching mechanism in the outboard motor according to the embodiment of the present disclosure;

FIG. 6 is a circuit diagram showing a cooling mechanism in the outboard motor according to the embodiment of the present disclosure;

FIG. 7 is a cross-sectional view taken along cutting line VI-VI in FIG. 4B, showing the first motor, the second motor, the first inverter, the second inverter, the motor holder, and the like;

FIG. 8 is a cross-sectional view taken along cutting line VIII-VIII in FIG. 4B, showing the first motor, the second motor, the first inverter, the second inverter, the motor holder, and the like;

FIG. 9 is a cross-sectional view taken along cutting line IX-IX in FIG. 7, showing the first motor, the first inverter, and the like; and

FIGS. 10A to 10C are explanatory views regarding effects of the cooling mechanism in the embodiment of the present disclosure.

### DESCRIPTION OF EMBODIMENTS

A ship propulsion machine according to an embodiment of the present disclosure includes a first motor, a second motor, a first inverter configured to generate a drive current for controlling drive of the first motor, a second inverter configured to generate a drive current for controlling drive of the second motor, a propeller, a power transmission mechanism configured to transmit power of each of the first motor and the second motor to the propeller, and a cooling mechanism configured to cool the first motor, the second motor, the first inverter, and the second inverter.

In the ship propulsion machine according to the present embodiment, the cooling mechanism includes: a first motor water jacket provided in the first motor and configured to cool the first motor by allowing cooling water to flow therein, a second motor water jacket provided in the second motor and configured to cool the second motor by allowing cooling water to flow therein, a first inverter water jacket provided in the first inverter and configured to cool the first inverter by allowing cooling water to flow therein, and a second inverter water jacket provided in the second inverter and configured to cool the second inverter by allowing cooling water to flow therein.

In addition, the cooling mechanism includes a first cooling water passage configured to allow cooling water to flow toward the first motor water jacket and the first inverter water jacket, a branch passage connecting the first motor water jacket and the first inverter water jacket to the first cooling water passage such that the first motor water jacket and the first inverter water jacket are connected in parallel with each other, and configured to distribute and supply cooling water flowing in the first cooling water passage to the first motor water jacket and the first inverter water jacket, a first connecting passage connecting the second motor water jacket to a downstream side of the first motor water jacket and configured to deliver cooling water flowing in the first motor water jacket to the second motor water jacket, and a second connecting passage connecting the second inverter water jacket to a downstream side of the first inverter water jacket and configured to deliver cooling water flowing in the first inverter water jacket to the second inverter water jacket.

In the cooling mechanism of the outboard motor according to the present embodiment, the first motor water jacket and the second motor water jacket, which are connected to each other by the first connecting passage, and the first inverter water jacket and the second inverter water jacket, which are connected to each other by the second connecting passage, are connected in parallel with each other, and are connected to the first cooling water passage. With this, a cooling water flow path within the cooling mechanism can be made shorter compared to a case where the first motor water jacket, the second motor water jacket, the first inverter water jacket, and the second inverter water jacket are connected in series to the first cooling water passage. This makes it possible to reduce pressure loss of the cooling water flowing through the flow path, thereby facilitating a flow of the cooling water. Therefore, the cooling efficiency for the first motor, the second motor, the first inverter, and the second inverter can be enhanced.

In addition, in the cooling mechanism according to the present embodiment, since the first motor water jacket and the second motor water jacket, which are connected to each other, and the first inverter water jacket and the second inverter water jacket, which are connected to each other, are connected in parallel with each other and are connected to the first cooling water passage via the branch passage, it becomes easy to individually set a flow rate of cooling water flowing in the first motor water jacket and second motor water jacket and a flow rate of the cooling water flowing in the first inverter water jacket and second inverter water jacket, respectively, in response to the amounts of heat generation of the first motor and second motor and the amounts of heat generation of the first inverter and second inverter. Therefore, it is possible to easily optimize the cooling capacity for cooling the first motor and the second motor, and the cooling capacity for cooling the first inverter and the second inverter, respectively.

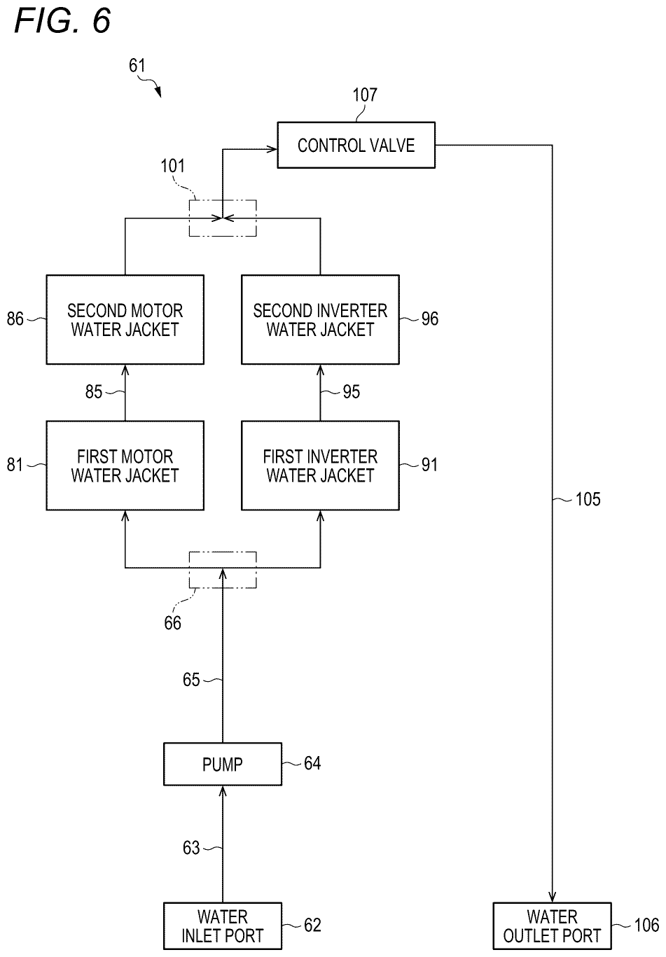

An embodiment of a ship propulsion machine of the present disclosure will be described with reference to the drawings. In the description of the present embodiment, when referring to upper (Ud), lower (Dd), front (Fd), rear (Bd), left (Ld), and right (Rd) directions, they follow arrows drawn at the lower right in each drawing except for FIG. 6.

### (Outboard Motor)

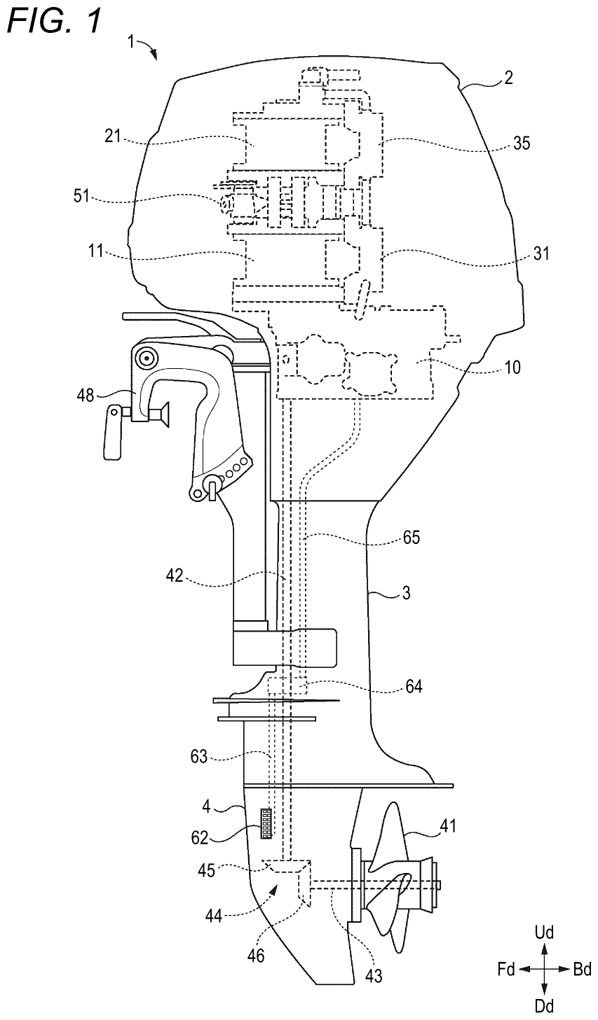

FIG. 1 shows an entire outboard motor 1, which is an embodiment of the ship propulsion machine of the present disclosure. In FIG. 1, the outboard motor 1 includes a first motor 11, a second motor 21, a first inverter 31, a second inverter 35, a propeller 41, a drive shaft 42, a propeller shaft 43, a gear mechanism 44, and a power switching mechanism 51. In addition, the outboard motor 1 includes a cooling mechanism 61 shown in FIG. 6.

The first motor 11 and the second motor 21 are each an AC motor and generate power to propel a ship. The first motor 11 is attached to a motor holder 10. The second motor 21 is attached to the first motor 11. The first inverter 31 is a device that generates a drive current for controlling drive of the first motor 11, and is attached to the first motor 11. The second inverter 35 is a device that generates a drive current for controlling drive of the second motor 21, and is attached to the second motor 21. The first motor 11, the second motor 21, the first inverter 31, the second inverter 35, and the motor holder 10 are arranged in an upper portion of the outboard motor 1 and covered with a motor cover 2.

The propeller 41 converts power of the first motor 11 and power of the second motor 21 into a propulsive force for a ship. The drive shaft 42, the propeller shaft 43, and the gear mechanism 44 are power transmission mechanisms that transmit the power of the first motor 11 and the power of the second motor 21 to the propeller 41. The propeller 41, the propeller shaft 43, and the gear mechanism 44 are arranged in a lower portion of the outboard motor 1. The drive shaft 42 extends vertically between the upper and lower portion of the outboard motor 1.

An upper end portion of the drive shaft 42 is connected to the first motor 11 and the second motor 21 via the power switching mechanism 51. The gear mechanism 44 includes a drive gear 45 and a driven gear 46, the drive gear 45 being fixed to a lower end portion of the drive shaft 42 and the driven gear 46 being fixed to a front end portion of the propeller shaft 43. The drive gear 45 and the driven gear 46 are both bevel gears and are in mesh with each other. Additionally, the propeller 41 is fixed to a rear end portion of the propeller shaft 43. Additionally, the drive shaft 42 is accommodated within a drive shaft case 3. Additionally, the propeller shaft 43 and the gear mechanism 44 are accommodated within a gear case 4.

The power switching mechanism 51 is a mechanism that switches a connection mode of the first motor 11, the second motor 21, and the drive shaft 42, and is arranged between the first motor 11 and the second motor 21.

In addition, the outboard motor 1 is provided with a clamp mechanism 48 for attaching the outboard motor 1 to a transom of the ship. In a state in which the outboard motor 1 is attached to the transom of the ship, the lower portion of the outboard motor 1, specifically, the lower portion of the drive shaft case 3 and the gear case 4, is located below a water surface.

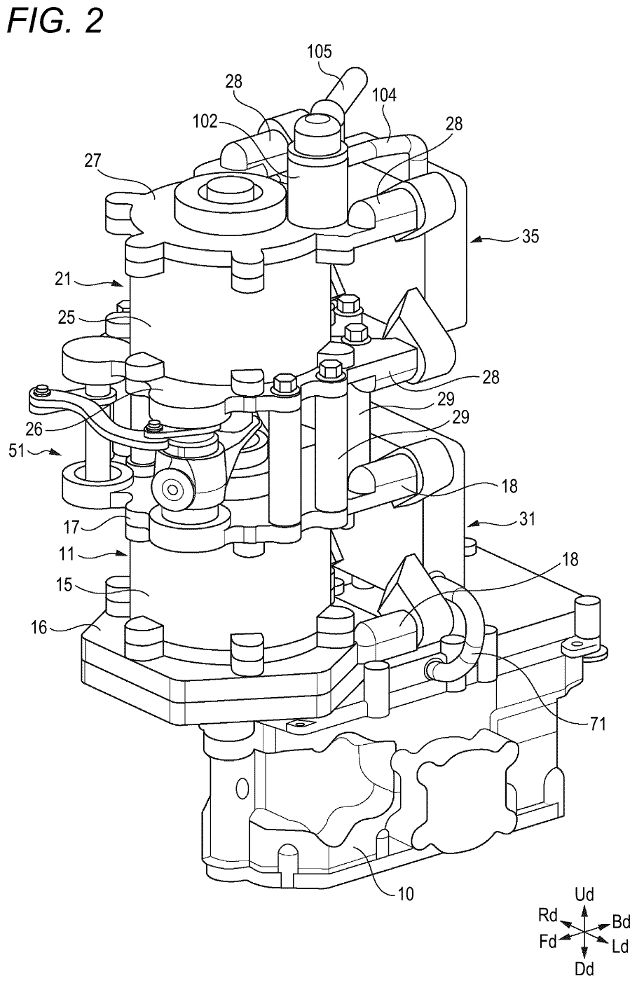

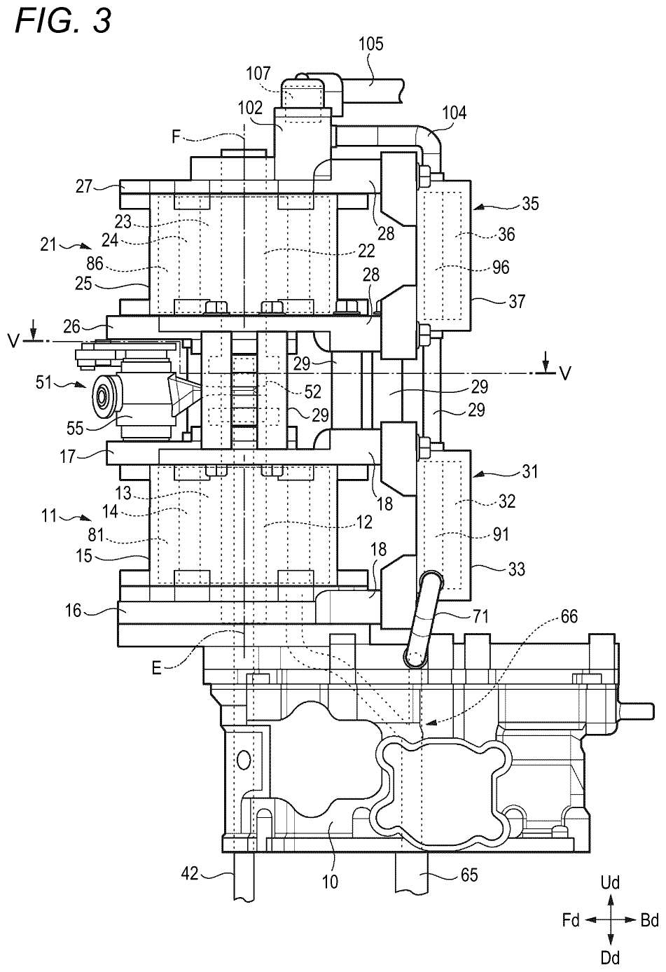

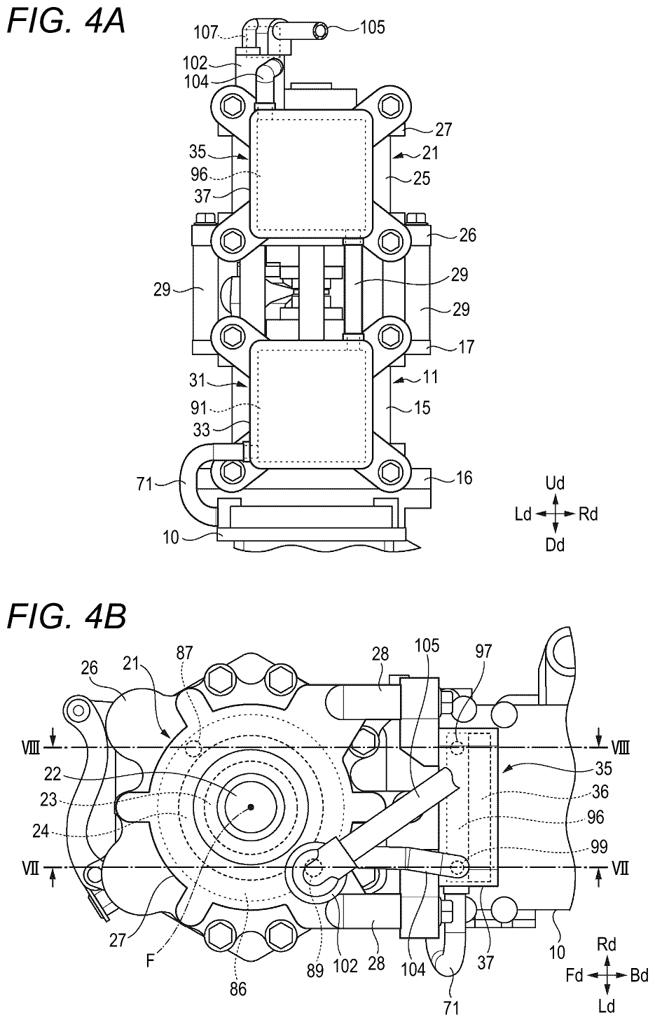

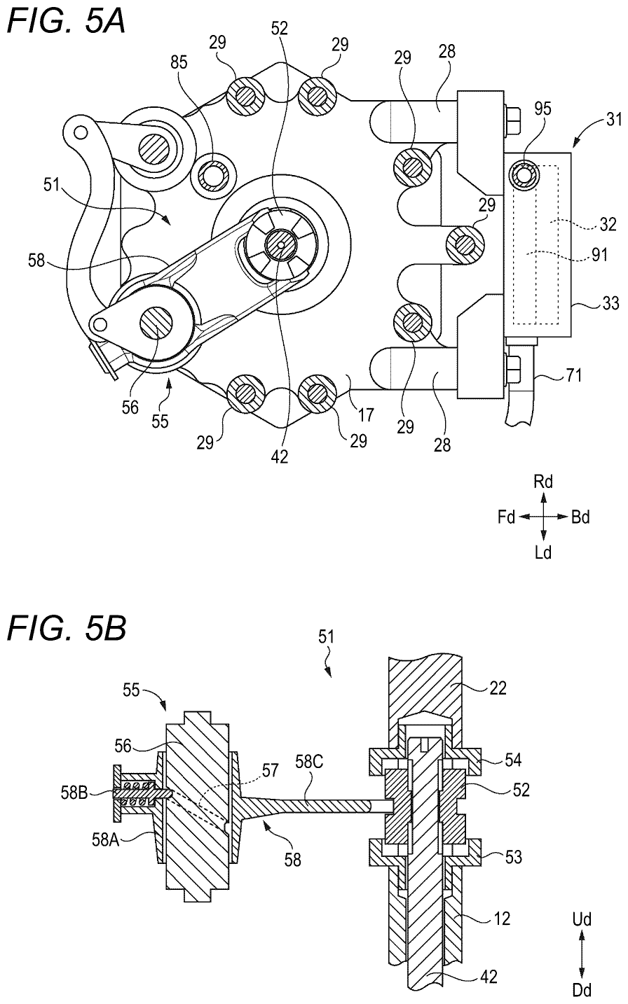

FIG. 2 shows a state of a unit formed by the first motor 11, the second motor 21, the first inverter 31, the second inverter 35, the motor holder 10, and the like, as viewed from the upper left of the front. FIG. 3 shows the unit, as viewed from the left. FIG. 4A shows the unit, as viewed from behind, and FIG. 4B shows the unit, as viewed from above. FIG. 5A is a cross-sectional view of the unit taken along cutting line V-V in FIG. 3, as seen from above. FIG. 5B shows the power switching mechanism 51.

As shown in FIG. 2, the motor holder 10 is a robust structure having a three-dimensional shape that serves as a base for the first motor 11 and the second motor 21 and is formed of, for example, a metal material. The first motor 11 is placed on an upper surface of a front portion of the motor holder 10 and is firmly fixed to the motor holder 10 using a fixing member such as a bolt.

As shown in FIG. 3, the first motor 11 includes a motor shaft 12, a rotor 13 provided on an outer periphery side of the motor shaft 12, a stator 14 provided on an outer periphery side of the rotor 13, a cylindrical motor housing 15 provided on an outer periphery side of the stator 14, and two motor brackets 16 and 17 provided on one side and other side (upper side and lower side) in an axial direction of the motor housing 15, respectively.

A basic structure of the second motor 21 is the same as that of the first motor 11. The second motor 21 includes a motor shaft 22, a rotor 23, a stator 24, a motor housing 25, and two motor brackets 26 and 27. Above all, as described below, the motor shaft 12 of the first motor 11 is formed in a tubular shape and has a structure in which an upper portion of the drive shaft 42 is inserted, while the motor shaft 22 of the second motor 21 does not have such a structure and is simply formed in a cylindrical shape.

The first inverter 31 includes an inverter body 32 and a rectangular parallelepiped inverter housing 33 that accommodates the inverter body 32. The inverter body 32 generates a drive current for controlling drive of the first motor 11 by converting current supplied from a battery from direct current to alternating current. The inverter body 32 includes a power semiconductor, which is a component that generates a large amount of heat, and the like.

A basic structure of the second inverter 35 is the same as that of the first inverter 31. The second inverter 35 includes an inverter body 36 and a rectangular parallelepiped inverter housing 37.

The first motor 11 is arranged on the motor holder 10 such that an extension direction of the motor shaft 12, i.e., an extension direction of a rotation axis E of the first motor 11, is oriented vertically. The second motor 21 is arranged above the first motor 11 such that an extension direction of the motor shaft 22, i.e., an extension direction of a rotation axis F of the second motor 21, is oriented vertically. Additionally, the first motor 11 and the second motor 21 are arranged such that the respective rotation axes E and F are coaxial.

Additionally, the second motor 21 is attached and fixed to the first motor 11 via a plurality of support members 29. That is, a plurality of support members 29 each extending vertically are provided between the motor bracket 17 on an upper side (upper motor bracket) of the first motor 11 and the motor bracket 26 on a lower side (lower motor bracket) of the second motor 21. As shown in FIG. 5A, the plurality of support members 29 are arranged on an outer periphery side of the motor brackets 17 and 26. For example, each support member 29 is formed with a bolt hole penetrating through the support member 29 in the axial direction, a location on the outer periphery side of the motor bracket 17 where the support member 29 is arranged is also formed with a bolt hole, and a location on the outer periphery side of the motor bracket 26 where the support member 29 is arranged is also formed with a bolt hole. Each support member 29 is fixed between the motor bracket 17 and the motor bracket 26 by inserting a long bolt into the bolt hole of the motor bracket 26, the bolt hole of the support member 29, and the bolt hole of the motor bracket 17, and fastening a nut onto an end portion of the bolt. With this, the second motor 21 is fixed above the first motor 11. In addition, the plurality of support members 29 are interposed between the first motor 11 and the second motor 21, so that a space is formed between the first motor 11 and the second motor 21.

Additionally, the first inverter 31 is arranged at the rear of the first motor 11. The first inverter 31 is attached and fixed to the first motor 11 via inverter attachment portions 18 provided on rear portions of the two motor brackets 16 and 17 of the first motor 11, respectively. Additionally, the second inverter 35 is arranged behind the second motor 21 and above the first inverter 31. The second inverter 35 is attached and fixed to the second motor 21 via inverter attachment portions 28 provided on rear portions of the two motor brackets 26 and 27 of the second motor 21, respectively. In addition, as shown in FIGS. 3 and 4A, the first inverter 31 and the second inverter 35 are the same in position in the front-rear direction and the left-right direction. That is, the second inverter 35 is arranged directly above the first inverter 31. In the present embodiment, ‘front-rear direction’ corresponds to an example of a “Y direction”, ‘above or upper side’ corresponds to an example of “one side in the X direction”, and ‘behind or rear side’ corresponds to an example of “one side in the Y direction”.

### (Power Switching Mechanism)

Here, the power switching mechanism 51 is described. The power switching mechanism 51 is a mechanism that switches a connection mode of the first motor 11, the second motor 21, and the drive shaft 42 among a connection mode A in which the first motor 11 and the second motor 21 are connected to the drive shaft 42, a connection mode B in which only the first motor 11 is connected to the drive shaft 42, and a connection mode C in which only the second motor 21 is connected to the drive shaft 42. In the connection mode A, the powers of both the first motor 11 and the second motor 21 are transmitted to the drive shaft 42, and the propeller 41 is rotated by a force obtained by combining the powers of both the first motor 11 and the second motor 21. In the connection mode B, only the power of the first motor 11 is transmitted to the drive shaft 42, and the propeller 41 is rotated only by the power of the first motor 11 of the first motor 11 and the second motor 21. In the connection mode C, only the power of the second motor 11 is transmitted to the drive shaft 42, and the propeller 41 is rotated only by the power of the second motor 21 of the first motor 11 and the second motor 21.

As shown in FIG. 5B, the upper end portion of the motor shaft 12 of the first motor 11 and the lower end portion of the motor shaft 22 of the second motor 21 face each other within the space formed between the first motor 11 and the second motor 21. Additionally, the upper portion of the drive shaft 42 passes through the inner periphery side of the cylindrical motor shaft 12 of the first motor 11 and is located within the space formed between the first motor 11 and the second motor 21. The upper portion of the drive shaft 42 is inserted into the inner periphery side of the motor shaft 12, but the outer peripheral surface of the drive shaft 42 and the inner peripheral surface of the motor shaft 12 are not in contact with each other. As a result, the drive shaft 42 and the motor shaft 12 can rotate independently.

In addition, a dog clutch 52 formed in a cylindrical shape is provided at the upper end portion of the drive shaft 42. The dog clutch 52 is attached to an outer periphery side of the upper end portion of the drive shaft 42 so as to be non-rotatable with respect to the drive shaft 42 and movable vertically with respect to the drive shaft 42. In addition, a fitted member 53 is attached and fixed to the upper end portion of the motor shaft 12 of the first motor 11. In addition, a fitted member 54 is attached and fixed to the lower end portion of the motor shaft 22 of the second motor 21. The dog clutch 52 is located between the fitted member 53 and the fitted member 54. Additionally, teeth are formed on each of lower and upper end portions of the dog clutch 52. In addition, teeth that can fit with the teeth on the lower end portion of the dog clutch 52 are formed on the fitted member 53, and teeth that can fit with the teeth on the upper end portion of the dog clutch 52 are formed on the fitted member 54.

In addition, a clutch control device 55 that switches and controls the dog clutch 52 is provided near the dog clutch 52 in the space between the first motor 11 and the second motor 21. The clutch control device 55 is arranged on a left front side of the first motor 11 and the second motor 21. The clutch control unit 55 includes a clutch camshaft 56, a cam groove 57, and a fork unit 58.

The clutch camshaft 56 extends vertically and has a lower end portion rotatably supported by the upper motor bracket 17 of the first motor 11 and an upper end portion rotatably supported by the lower motor bracket 26 of the second motor 21. The cam groove 57 is formed on an outer peripheral surface of the clutch camshaft 56. The fork unit 58 is attached to the clutch camshaft 56. The fork unit 58 includes a cylindrical base portion 58A, a driven pin 58B provided in the base portion 58A, and a fork portion 58C extending from the base portion 58A toward the dog clutch 52. The base portion 58A is arranged on an outer periphery side of the clutch camshaft 56, and a tip end portion of the driven pin 58B is inserted into the cam groove 57 of the clutch camshaft 56. In addition, a tip end portion of the fork portion 58C is split into two prongs, gripping the dog clutch 52, as shown in FIG. 5A. The gripping on the dog clutch 52 by the fork portion 58C is not strong, and therefore, the dog clutch 52 can rotate while being gripped by the fork portion 58C.

A cylindrical cam is constituted by the clutch camshaft 56 and the fork unit 58. For example, when the clutch camshaft 56 rotates in one direction, the fork unit 58 moves upward, and along with this, the dog clutch 52 moves upward. On the other hand, when the clutch camshaft 56 rotates in the other direction, the fork unit 58 moves downward, and along with this, the dog clutch 52 moves downward.

When the dog clutch 52 is located at a middle position between the fitted member 53 and the fitted member 54, the teeth on the lower end portion of the dog clutch 52 and the teeth on the fitted member 53 fit with each other, and at the same time, the teeth on the upper end portion of the dog clutch 52 and the teeth on the fitted member 54 fit with each other. With this, both the motor shaft 12 of the first motor 11 and the motor shaft 22 of the second motor 21 are connected to the drive shaft 42, and the connection mode of the first motor 11, the second motor 21, and the drive shaft 42 becomes the connection mode A.

In addition, when the dog clutch 52 moves to a lower position between the fitted member 53 and the fitted member 54, the teeth on the lower end portion of the dog clutch 52 and the teeth on the fitted member 53 fit with each other, and the fitting between the teeth on the upper end portion of the dog clutch 52 and the teeth on the fitted member 54 is released. With this, only the motor shaft 12 of the first motor 11 is connected to the drive shaft 42, and the connection mode of the first motor 11, the second motor 21, and the drive shaft 42 becomes the connection mode B.

In addition, when the dog clutch 52 moves to an upper position between the fitted member 53 and the fitted member 54, the teeth on the upper end portion of the dog clutch 52 and the teeth on the fitted member 54 fit with each other, and the fitting between the teeth on the lower end portion of the dog clutch 52 and the teeth on the fitted member 53 is released. With this, only the motor shaft 22 of the second motor 21 is connected to the drive shaft 42, and the connection mode of the first motor 11, the second motor 21, and the drive shaft 42 becomes the connection mode C.

Although not shown, the outboard motor 1 is provided with an actuator (e.g., a DC motor) that rotates the clutch camshaft 56 based on an operation signal input from the outside, and is adapted to switch the connection mode of the first motor 11, the second motor 21, and the drive shaft 42 based on the operation signal.

The outboard motor 1 includes the first motor 11 and the second motor 21 and can switch the connection mode of the first motor 11, the second motor 21, and the drive shaft 42. Therefore, the performance of the outboard motor 1 can be enhanced. Specifically, the output or torque of the outboard motor 1 can be significantly changed in response to sailing conditions of the ship, and the power consumption of the outboard motor 1 can be adjusted. In addition, for example, when one of the first motor 11 and the second motor 21 fails during sailing, the failed motor can be disconnected from the drive shaft 42 and the non-failed motor can be connected to the drive shaft 42, allowing the propeller 41 to rotate only with the power of the non-failed motor, thereby moving the ship.

### (Configuration of Cooling Mechanism)

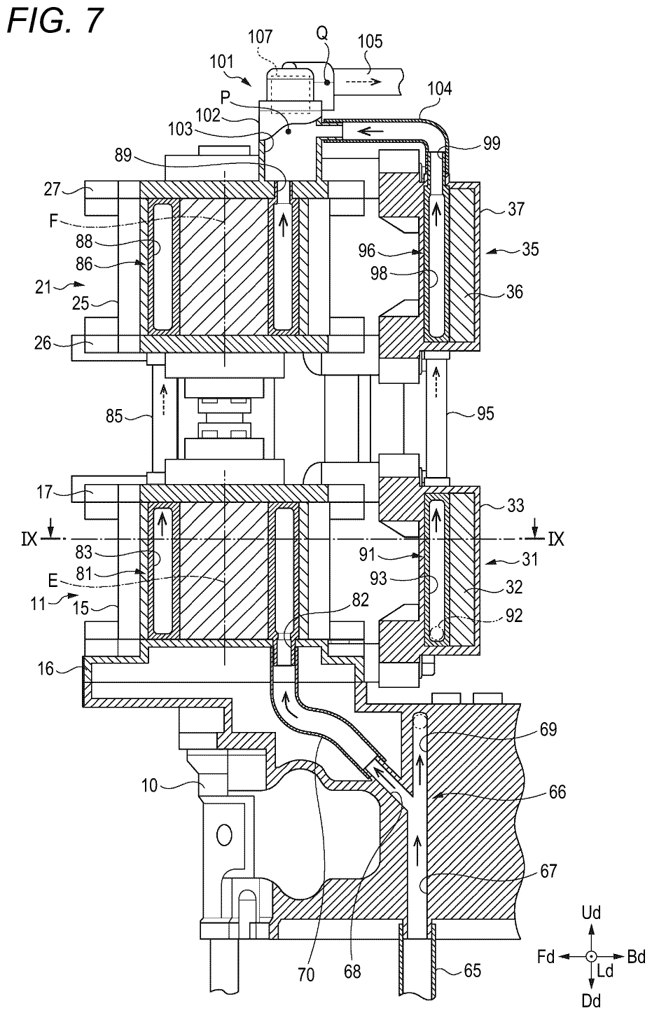

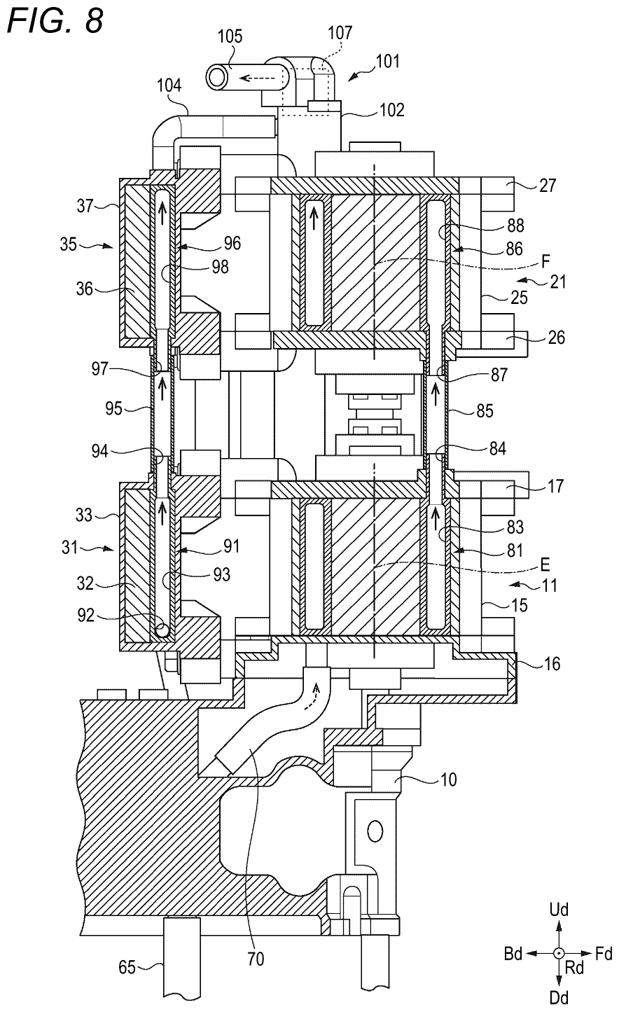

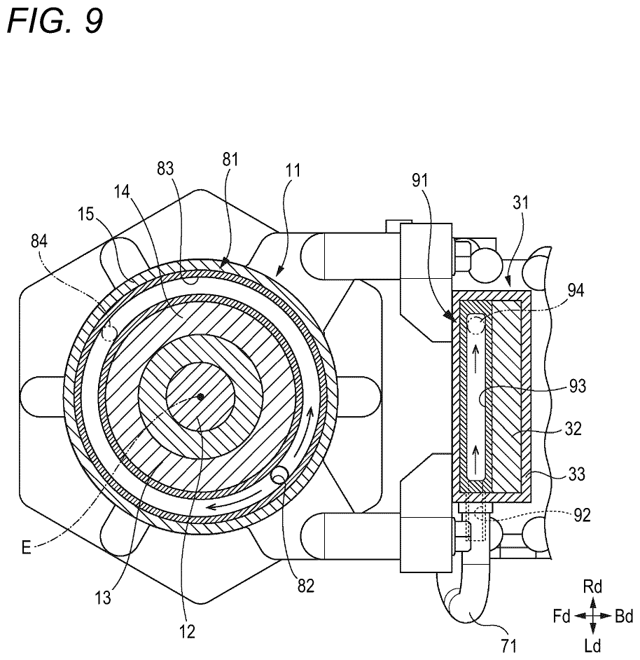

FIG. 6 shows a configuration of the cooling mechanism 61 provided in the outboard motor 1. FIG. 7 is a cross-sectional view taken along cutting line VII-VII in FIG. 4B, showing a unit formed by the first motor 11, the second motor 21, the first inverter 31, the second inverter 35, the motor holder 10, and the like, as viewed from the left (from below in FIG. 4B). FIG. 8 is a cross-sectional view of the unit taken along cutting line VIII-VIII in FIG. 4B, as viewed from the right (from above in FIG. 4B). FIG. 9 is a cross-sectional view of the unit taken along cutting line IX-IX in FIG. 7, as viewed from above.

The cooling mechanism 61 is a mechanism that uses water around the outboard motor 1 as cooling water and cools the first motor 11, the second motor 21, the first inverter 31, and the second inverter 35. As shown in FIG. 6, the cooling mechanism 61 includes a water inlet port 62, a water intake passage 63, a pump 64, a cooling water supply passage 65, a branch passage 66, a first motor water jacket 81, a motor water jacket connecting pipe 85, a second motor water jacket 86, a first inverter water jacket 91, an inverter water jacket connecting pipe 95, a second inverter water jacket 96, a joint passage 101, a cooling water discharge passage 105, a water outlet port 106, and a control valve 107.

As shown in FIG. 1, the water inlet port 62 is an inlet for drawing water from around the outboard motor 1 into the cooling mechanism 61 and is provided on the gear case 4. A strainer is attached to the water inlet port 62 to prevent trash, algae, or the like in the water around the outboard motor 1 from entering the cooling mechanism 61.

The water intake passage 63 is a passage that connects the water inlet port 62 and a suction port of the pump 64 and delivers water flowing into the water inlet port 62 to the pump 64.

The pump 64 is a device that causes cooling water to flow in the cooling mechanism 61 by drawing up water flowing into the water inlet port 62 and discharging the water as cooling water into the cooling water supply passage 65. As the pump 64, various pumps can be used, such as a Jabsco pump. In the present embodiment, the pump 64 is driven using rotation of the drive shaft 42.

The cooling water supply passage 65 is a passage that allows cooling water to flow toward the first motor water jacket 81 and the first inverter water jacket 91. The cooling water supply passage 65 is formed by, for example, a hose. A lower end portion of the cooling water supply passage 65 is connected to a discharge port of the pump 64, and an upper end portion of the cooling water supply passage 65 is connected to the branch passage 66, as shown in FIG. 7. The cooling water supply passage serves as an example of a “first cooling water passage.”

As shown in FIG. 6, the branch passage 66 is a passage that connects the first motor water jacket 81 and the first inverter water jacket 91 to the cooling water supply passage 65 such that the first motor water jacket 81 and the first inverter water jacket 91 are connected in parallel with each other, and distributes and supplies cooling water flowing in the cooling water supply passage 65 to the first motor water jacket 81 and the first inverter water jacket 91. The branch passage 66 is formed by a trunk passage hole 67, a branched passage hole 68, and a branched passage hole 69 formed in the motor holder 10 as shown in FIG. 7, a connecting pipe 70 shown in FIG. 7, and a connecting pipe 71 shown in FIG. 3. As shown in FIG. 7, the upper end portion of the cooling water supply passage 65 is connected to a lower end portion of the trunk passage hole 67. The trunk passage hole 67 extends upward in the motor holder 10 and then branches into the two branched passage holes 68 and 69. A lower end portion of the connecting pipe 70 arranged in the motor holder 10 is connected to an upper end portion of one branched passage hole 68, and an upper end portion of the connecting pipe 70 is connected to an inlet 82 of the first motor water jacket 81. As shown in FIG. 3, a lower end portion of the connecting pipe 71 arranged outside the motor holder 10 is connected to an upper end portion of the other branched passage hole 69, and an upper end portion of the connecting pipe 71 is connected to an inlet 92 of the first inverter water jacket 91.

The first motor water jacket 81 is a mechanism that is provided in the first motor 11 and cools the first motor 11 by allowing cooling water to flow therein. The first motor water jacket 81 is provided to surround the first motor 11 on the outer periphery side of the first motor 11, as shown in FIG. 9. Specifically, the first motor water jacket 81 is arranged between the stator 14 of the first motor 11 and the motor housing 15 and surrounds the stator 14. Additionally, an internal passage 83 for allowing cooling water to flow is formed in the first motor water jacket 81. The internal passage 83 surrounds the stator 14. In addition, as shown in FIG. 7, the first motor water jacket 81 widely covers the stator 14 from a lower end-side portion to an upper end-side portion of the stator 14. Additionally, the internal passage 83 is formed from the lower end-side portion to the upper end-side portion of the stator 14.

Additionally, the first motor water jacket 81 has an inlet 82 that allows cooling water supplied through the branch passage 66 to flow into the internal passage 83 of the first motor water jacket 81. The inlet 82 communicates with the inside of the internal passage 83. The inlet 82 is arranged at a left rear portion of the lower portion of the first motor 11, as shown in FIGS. 7 and 9. Additionally, the inlet 82 opens downward toward the outside of the first motor water jacket 81. Additionally, the upper end portion of the connecting pipe 70 of the branch passage 66 is connected to the inlet 82.

In addition, the first motor water jacket 81 has an outlet 84 that allows cooling water flowing in the internal passage 83 of the first motor water jacket 81 to flow out to the outside of the first motor water jacket 81. The outlet 84 communicates with the inside of the internal passage 83. The outlet 84 is arranged at a right front portion of the upper portion of the first motor 11, as shown in FIGS. 8 and 9. Additionally, the outlet 84 opens upward toward the outside of the first motor water jacket 81. Additionally, a lower end portion of the motor water jacket connecting pipe 85 is connected to the outlet 84.

The motor water jacket connecting pipe 85 is a pipe, a hose or the like that connects the second motor water jacket 86 to a downstream side of the first motor water jacket 81 and forms a passage for delivering cooling water flowing in the first motor water jacket 81 to the second motor water jacket 86. As shown in FIG. 8, the motor water jacket connecting pipe 85 extends vertically in a straight line, with a lower end portion connected to the outlet 84 of the first motor water jacket 81 and an upper end portion connected to the inlet 87 of the second motor water jacket 86. In addition, the motor water jacket connecting pipe 85 is arranged at a right front portion between the first motor 11 and the second motor 21, as shown in FIG. 5A. The motor water jacket connecting pipe 85 serves as an example of a “first connecting passage.”

The second motor water jacket 86 is a mechanism that is provided in the second motor 21 and cools the second motor 21 by allowing cooling water to flow therein. The second motor water jacket 86 is provided to surround the second motor 21 on the outer periphery side of the second motor 21, as shown in FIGS. 3, 4A, 4B, 7, and 8. Specifically, the second motor water jacket 86 is arranged between the stator 24 of the second motor 21 and the motor housing 25 and surrounds the stator 24. A basic structure of the second motor water jacket 86 is the same as that of the first motor water jacket 81. An internal passage 88 formed inside the second motor water jacket 86 surrounds the stator 24 of the second motor 21. Additionally, the internal passage 88 is formed from the lower end-side portion to the upper end-side portion of the stator 24. Additionally, the second motor water jacket 86 has an inlet 87 that allows cooling water flowing out from the outlet 84 of the first motor water jacket 81 and delivered through the motor water jacket connecting pipe 85 to flow into the internal passage 88 of the second motor water jacket 86. In addition, the second motor water jacket 86 has an outlet 89 that allows cooling water flowing in the internal passage 88 of the second motor water jacket 86 to flow out to the outside of the second motor water jacket 86.

Above all, the arrangement of the inlet 87 of the second motor water jacket 86 is different from the arrangement of the inlet 82 of the first motor water jacket 81. The inlet 82 of the first motor water jacket 81 is arranged at the left rear portion of the lower portion of the first motor 11, while the inlet 87 of the second motor water jacket 86 is arranged at the right front portion of the lower portion of the second motor 21, as shown in FIG. 8. Additionally, the inlet 87 of the second motor water jacket 86 is arranged directly above the outlet 84 of the first motor water jacket 81. That is, the positions of the outlet 84 of the first motor water jacket 81 and the inlet 87 of the second motor water jacket 86 in the front-rear direction and the left-right direction are the same as each other. Additionally, the inlet 87 opens downward toward the outside of the second motor water jacket 86. Additionally, the upper end portion of the motor water jacket connecting pipe 85 is connected to the inlet 87 of the second motor water jacket 86. The outlet 84 of the first motor water jacket 81 and the inlet 87 of the second motor water jacket 86 are the same in positions in the front-rear direction and the left-right direction and are opened to face each other, so the motor water jacket connecting pipe 85 connecting the outlet 84 of the first motor water jacket 81 and the inlet 87 of the second motor water jacket 86 extends in a straight line.

Additionally, the arrangement of the outlet 89 of the second motor water jacket 86 is different from the arrangement of the outlet 84 of the first motor water jacket 81. The outlet 84 of the first motor water jacket 81 is arranged at the right front portion of the upper portion of the first motor 11, while the outlet 89 of the second motor water jacket 86 is arranged at the left rear portion of the upper portion of the second motor 21, as shown in FIG. 7. Additionally, the outlet 89 opens upward toward the outside of the second motor water jacket 86. The internal passage 88 of the second motor water jacket 86 communicates with an inside of a joint chamber 103 through the outlet 89.

The first inverter water jacket 91 is a mechanism that is provided in the first inverter 31 and cools the inverter body 32 of the first inverter 31 by allowing cooling water to flow therein. As shown in FIGS. 7 and 9, the first inverter water jacket 91 is provided within the inverter housing 33 of the first inverter 31 and arranged in front of the inverter body 32. The first inverter water jacket 91 widely covers a front surface of the inverter body 32 from a left end portion to a right end portion and from a lower end portion to an upper end portion. Additionally, an internal passage 93 for allowing cooling water to flow is formed inside the first inverter water jacket 91. The internal passage 93 is formed to widely cover the front surface of the inverter body 32 from the left end portion to the right end portion and from the lower end portion to the upper end portion.

Additionally, the first inverter water jacket 91 has an inlet 92 that allows cooling water supplied through the branch passage 66 to flow into the internal passage 93 of the first inverter water jacket 91. The inlet 92 communicates with the inside of the internal passage 93. The inlet 92 is arranged at a lower left portion of the first inverter 31, as shown in FIG. 9. Additionally, the inlet 92 opens leftward toward the outside of the first inverter water jacket 91. Additionally, the upper end portion of the connecting pipe 71 of the branch passage 66 is connected to the inlet 92.

In addition, the first inverter water jacket 91 has an outlet 94 that allows cooling water flowing in the internal passage 93 of the first inverter water jacket 91 to flow out to the outside of the first inverter water jacket 91. The outlet 94 communicates with the internal passage 93. The outlet 94 is arranged at an upper right portion of the first inverter 31, as shown in FIG. 8. Additionally, the outlet 94 opens upward toward the outside of the first inverter water jacket 91. Additionally, a lower end portion of the inverter water jacket connecting pipe 95 is connected to the outlet 94.

The inverter water jacket connecting pipe 95 is a pipe, a hose or the like that connects the second inverter water jacket 96 to a downstream side of the first inverter water jacket 91 and forms a passage for delivering cooling water flowing in the first inverter water jacket 91 to the second motor water jacket 96. The inverter water jacket connecting pipe 95 is arranged between a right portion of the first inverter 31 and a right portion of the second inverter 35, as shown in FIGS. 4A, 4B, and 8. In addition, the inverter water jacket connecting pipe 95 extends vertically in a straight line, with a lower end portion connected to the outlet 94 of the first inverter water jacket 91 and an upper end portion connected to the inlet 97 of the second inverter water jacket 96. The inverter water jacket connecting pipe 95 serves as an example of a “second connecting passage.”

The second inverter water jacket 96 is a mechanism that is provided in the second inverter 35 and cools the second inverter 35 by allowing cooling water to flow therein. The second inverter water jacket 96 is provided within the inverter housing 37 of the second inverter 35 and is arranged in front of the inverter main body 36. A basic structure of the second inverter water jacket 96 is the same as that of the first inverter water jacket 91. The internal passage 98 formed inside the second inverter water jacket 96 widely covers a front surface of the inverter body 36 from a left end portion to a right end portion and from a lower end portion to an upper end portion. Additionally, the second inverter water jacket 96 has an inlet 97 that allows cooling water flowing out from the outlet 94 of the first inverter water jacket 91 and delivered through the inverter water jacket connecting pipe 95 to flow into the internal passage 98 of the second inverter water jacket 96. In addition, the second inverter water jacket 96 has an outlet 99 that allows cooling water flowing in the internal passage 98 of the second inverter water jacket 96 to flow out to the outside of the second inverter water jacket 96.

Above all, the arrangement of the inlet 97 of the second inverter water jacket 96 is different from the arrangement of the inlet 92 of the first inverter water jacket 91. The inlet 92 of the first inverter water jacket 91 is arranged at the lower left portion of the first inverter 31, while the inlet 97 of the second inverter water jacket 96 is arranged at the lower right portion of the second inverter 35, as shown in FIG. 8. Additionally, the inlet 97 of the second inverter water jacket 96 is arranged directly above the outlet 94 of the first inverter water jacket 91. That is, the positions of the outlet 94 of the first inverter water jacket 91 and the inlet 97 of the second motor water jacket 96 in the front-rear direction and the left-right direction are the same as each other. Additionally, the inlet 97 opens downward toward the outside of the second inverter water jacket 96. Additionally, the upper end portion of the inverter water jacket connecting pipe 95 is connected to the inlet 97 of the second inverter water jacket 96. The outlet 94 of the first inverter water jacket 91 and the inlet 97 of the second inverter water jacket 96 are the same in positions in the front-rear direction and the left-right direction and are opened to face each other, so the inverter water jacket connecting pipe 95 connecting the outlet 94 of the first inverter water jacket 91 and the inlet 97 of the second inverter water jacket 96 extends in a straight line.

Additionally, the arrangement of the outlet 99 of the second inverter water jacket 96 is different from the arrangement of the outlet 94 of the first inverter water jacket 91. The outlet 94 of the first inverter water jacket 91 is arranged at the upper right portion of the first inverter 31, while the outlet 99 of the second inverter water jacket 96 is arranged at the upper left portion of the second inverter 35, as shown in FIG. 7. Additionally, the outlet 99 opens upward toward the outside of the second inverter water jacket 96. Additionally, a lower end portion of a connecting pipe 104 is connected to the outlet 99. In addition, as shown in FIG. 4B, the position of the outlet 99 of the second inverter water jacket 96 is substantially the same as the position of the outlet 89 of the second motor water jacket 86 in the left-right direction. In the present embodiment, the left-right direction corresponds to an example of a “Z direction”, the left or left side corresponds to an example of “one side in the Z direction”, and the right or right side corresponds to an example of “the other side in the Z direction”.

The joint passage 101 is a passage that is connected to the outlet 89 of the second motor water jacket 86, the outlet 99 of the second inverter water jacket 96, and the cooling water discharge passage 105, joins the cooling water flowing from the outlet 89 of the second motor water jacket 86 with the cooling water flowing from the outlet 99 of the inverter water jacket 96, and allows the joined cooling water to flow into the cooling water discharge passage 105. As shown in FIG. 7, the joint passage 101 is formed by a joint chamber 103 and a connecting pipe 104. As shown in FIG. 2, a joint chamber forming portion 102 protruding upward is formed at a left rear portion of the upper motor bracket 27 of the second motor 21. As shown in FIG. 7, the joint chamber 103 is formed in the joint chamber forming portion 102. The outlet 89 of the second motor water jacket 86 is connected to a bottom portion of the joint chamber forming portion 102, and the internal passage 88 of the second motor water jacket 86 communicates with an inside of the joint chamber 103 through the outlet 89. In addition, a front end portion of the connecting pipe 104 is connected to a rear portion of a peripheral portion of the joint chamber forming portion 102, and the internal passage 98 of the second inverter water jacket 96 communicates with the inside of the joint chamber 103 through the outlet 99 and the connecting pipe 104. In addition, an upper end portion of the cooling water discharge passage 105 is connected to an upper portion of the joint chamber forming portion 102, and the joint chamber 103 communicates with an inside of the cooling water discharge passage 105.

The cooling water discharge passage 105 is a passage that allows cooling water, which has flowed out from the inside of the second motor water jacket 86 and the inside of the second inverter water jacket 96, to flow therein. A lower end side of the cooling water discharge passage 105 is connected to the water outlet 106 (see FIG. 6). The water outlet 106 is provided, for example, at a rear portion of the lower portion of the outboard motor 1. In addition, the cooling water discharge passage 105 serves as an example of a “second cooling water passage.”

The control valve 107 is a valve that controls a flow rate of cooling water after joining in the joint passage 101. As shown in FIG. 7, the control valve 107 is arranged at an upper portion of the joint chamber 103 and between a joint position P where the cooling water flowing out from the outlet 89 of the second motor water jacket 86 joins the cooling water flowing out from the outlet 99 of the second inverter water jacket 96 and a connection position Q of the cooling water discharge passage 105. The control valve 107 changes a degree of valve opening in response to a temperature of the cooling water after joining, thereby regulating the temperature of the cooling water. Specifically, the control valve 107 increases the degree of valve opening in response to an increase in the temperature of the cooling water after joining. With this, when the temperature of the cooling water rises, the flow rates of the cooling water flowing in the first motor water jacket 81, the second motor water jacket 86, the first inverter water jacket 91, and the second inverter water jacket 96 can be increased, thereby lowering the temperature of the cooling water. For example, the control valve 107 has a sensor that detects a temperature of the cooling water in the joint chamber 103. As the control valve 107, for example, a thermostat may be used.

A bypass passage for directly connecting the cooling water supply passage 65 and the water outlet 106 may be added, and the bypass passage may be provided with a relief valve to connect and block the bypass passage. The relief valve closes when a pressure in the cooling water supply passage 65 falls to a predetermined pressure or below, and opens when the pressure in the cooling water supply passage 65 exceeds the predetermined pressure.

### (Operation of Cooling Mechanism)

An operation of the cooling mechanism 61 is as follows. The pump 64 is driven as the drive shaft 42 is rotated by drives of the first motor 11 and the second motor 21. As the pump 64 is driven, water flowing into the water inlet port 62 is drawn up, flows through the water intake passage 63, flows into the suction port of the pump 64, and continues to flow into the cooling water supply passage 65 as cooling water from the discharge port of the pump 64. The cooling water flows in the cooling water supply passage 65, moves to the upper portion of the outboard motor 1, and flows into the trunk passage hole 67 of the branch passage 66. In the branch passage 66, the cooling water flowing into the trunk passage hole 67 is divided into cooling water flowing in the branched passage hole 68 and the connecting pipe 70, and cooling water flowing in the branched passage hole 69 and the connecting pipe 71.

The cooling water flowing in the branched passage hole 68 and the connecting pipe 70 passes through the inlet 82 of the first motor water jacket 81 and flows into the internal passage 83 of the first motor water jacket 81. The cooling water flowing into the internal passage 83 flows in the internal passage 83, receives heat from the first motor 11 during the flow, and passes through the outlet 84 of the first motor water jacket 81 to flow into the motor water jacket connecting pipe 85.

The cooling water flowing into the motor water jacket connecting pipe 85 flows in the motor water jacket connecting pipe 85 and passes through the inlet 87 of the second motor water jacket 86 to flow into the internal passage 88 of the second motor water jacket 86. The cooling water flowing into the internal passage 88 flows in the internal passage 88, receives heat from the second motor 21 during the flow, and passes through the outlet 89 of the second motor water jacket 86 to flow into the joint chamber 103.

On the other hand, the cooling water flowing in the branched passage hole 69 and the connecting pipe 71 passes through the inlet 92 of the first inverter water jacket 91 and flows into the internal passage 93 of the first inverter water jacket 91. The cooling water flowing into the internal passage 93 flows in the internal passage 93, receives heat from the inverter body 32 of the first inverter 31 during the flow, and passes through the outlet 94 of the first inverter water jacket 91 to flow into the inverter water jacket connecting pipe 95.

The cooling water flowing into the inverter water jacket connecting pipe 95 flows in the inverter water jacket connecting pipe 95 and passes through the inlet 97 of the second inverter water jacket 96 to flow into the internal passage 98 of the second inverter water jacket 96. The cooling water flowing into the internal passage 98 flows in the internal passage 98, receives heat from the inverter body 36 of the second inverter 35 during the flow, and passes through the outlet 99 of the second inverter water jacket 96 to flow into the connecting pipe 104. Subsequently, the cooling water flows in the connecting pipe 104 and flows into the joint chamber 103.

The cooling water passing through the outlet 89 of the second motor water jacket 86 to flow into the joint chamber 103 and the cooling water passing through the outlet 99 of the second inverter water jacket 96, flowing in the connecting pipe 104, and flowing into the joint chamber 103 join in the joint chamber 103. The joined cooling water flows into the cooling water discharge passage 105 from the joint chamber 103, flows in the cooling water discharge passage 105, and is discharged outside the outboard motor 1 through the water outlet 106.

In addition, the flow rates of cooling water flowing in the first motor water jacket 81, the second motor water jacket 86, the first inverter water jacket 91, and the second inverter water jacket 96 are adjusted by the degree of valve opening of the control valve 107. As a result, the temperature of the cooling water can be regulated. When the degree of valve opening of the control valve 107 increases, the flow rate of the cooling water flowing in each of the water jackets 81, 86, 91, and 96 increases, the temperature of the cooling water decreases, and the cooling capacity of the cooling water to cool the first motor 11, the second motor 21, the inverter body 32 of the first inverter, and the inverter body 36 of the second inverter 35 is enhanced. On the other hand, when the degree of valve opening of the control valve 107 decreases, the flow rate of cooling water flowing in each of the water jackets 81, 86, 91, and 96 decreases.

### (Main Features and Effects of Cooling Mechanism)

(1) In the cooling mechanism 61 of the outboard motor 1 of the embodiment of the present disclosure, as shown in FIG. 6, the first motor water jacket 81 and the second motor water jacket 86, which are connected to each other by the motor water jacket connecting pipe 85, and the first inverter water jacket 91 and the second inverter water jacket 96, which are connected to each other by the inverter water jacket connecting pipe 95, are connected in parallel between the cooling water supply passage 65 and the cooling water discharge passage 105. In this configuration, a length of a cooling water flow path from the cooling water supply passage 65, through the first motor water jacket 81 and the second motor water jacket 86 in sequence, to the cooling water discharge passage 105, and a length of a cooling water flow path from the cooling water supply passage 65, through the first inverter water jacket 91 and the second inverter water jacket 96 in sequence, to the cooling water discharge passage 105 are both shorter than a length of a cooling water flow path from the cooling water supply passage 65, through the four water jackets 81, 86, 91, and 96 in sequence, to the cooling water discharge passage 105 when the four water jackets 81, 86, 91, and 96 are connected in series between the cooling water supply passage 65 and the cooling water discharge passage 105. Accordingly, according to the cooling mechanism 61 of the present embodiment, compared to the case where the four water jackets 81, 86, 91, and 96 are connected in series between the cooling water supply passage 65 and the cooling water discharge passage 105, the pressure loss of the cooling water flowing in the cooling mechanism 61 can be reduced, and therefore the flow of the cooling water in the cooling mechanism 61 can be made smooth. Therefore, the cooling efficiency for the first motor 11, the second motor 21, the first inverter 31, and the second inverter 35 can be enhanced.

In addition, in the cooling mechanism 61 of the present embodiment, the first motor water jacket 81 and the second motor water jacket 86, connected to each other, and the first inverter water jacket 91 and the second inverter water jacket 96, connected to each other, are connected in parallel between the cooling water supply passage 65 and the cooling water discharge passage 105, so the flow rate of the cooling water flowing in the first motor water jacket 81 and the second motor water jacket 86 and the flow rate of the cooling water flowing in the first inverter water jacket 91 and the second inverter water jacket 96 can be individually set, respectively, in response to the amounts of heat generation of the first motor 11 and the second motor 21 and the amounts of heat generation of the first inverter 31 and the second inverter 35. Accordingly, the cooling capacity for cooling the first motor 11 and the second motor 21 and the cooling capacity for cooling the first inverter 31 and the second inverter 35 can be individually and easily optimized, respectively. For example, when the amounts of heat generation of the first motor 11 and the second motor 21 are greater than the amounts of heat generation of the first inverter 31 and the second inverter 35, diameters of the branched passage hole 68 of the branch passage 66 and the connecting pipe 70 are made larger than diameters of the branched passage hole 69 and the connecting pipe 71, allowing the flow rate of the cooling water flowing from the trunk passage hole 67, through the branched passage hole 68 and the connecting pipe 70, into the first motor water jacket 81 to be greater than the flow rate of the cooling water flowing from the trunk passage hole 67, through the branched passage hole 69 and the connecting pipe 71, into the first inverter water jacket 91. With this, the cooling capacity for cooling the first motor 11 and the second motor 21 can be easily increased higher than the cooling capacity for cooling the first inverter 31 and the second inverter 35.
(2) In the cooling mechanism 61 of the outboard motor 1 of the present embodiment, in addition to the first motor water jacket 81 and the second motor water jacket 86, which are connected to each other, and the first inverter water jacket 91 and the second inverter water jacket 96, which are connected to each other, being connected in parallel between the cooling water supply passage 65 and the cooling water discharge passage 105, as shown in FIGS. 7 and 8, the first motor 11 and the second motor 21 are arranged such that the extension directions of the rotation axes E and F thereof are oriented vertically, the second motor 21 is arranged above the first motor 11, the first inverter 31 is arranged behind the first motor 11, the second inverter 35 is arranged behind the second motor 21 and above the first inverter 31, the inlet 82 of the first motor water jacket 81, the inlet 87 of the second motor water jacket 86, the inlet 92 of the first inverter water jacket 91, and the inlet 97 of the second inverter water jacket 96 are arranged at the lower portions of the first motor 11, the second motor 21, the first inverter 31, and the second inverter 35, respectively, and the outlet 84 of the first motor water jacket 81, the outlet 89 of the second motor water jacket 86, the outlet 94 of the first inverter water jacket 91, and the outlet 99 of the second inverter water jacket 96 are arranged at the upper portions of the first motor 11, the second motor 21, the first inverter 31, and the second inverter 35, respectively. With this configuration, the branch passage 66, the motor water jacket connecting pipe 85, the inverter water jacket connecting pipe 95, and the joint 101 can be made short, respectively. Accordingly, the pressure loss of the cooling water flowing in the cooling mechanism 61 can be reduced, and therefore the flow of the cooling water in the cooling mechanism 61 can be made smooth. Therefore, the cooling efficiency for the first motor 11, the second motor 21, the first inverter 31, and the second inverter 35 can be enhanced.

That is, in the first motor water jacket 81 and the first inverter water jacket 91 arranged at the lower stage, the inlet 82 and the inlet 92 can be brought close to each other by arranging the inlet 82 and the inlet 92 at the lower portions of the first motor 11 and the first inverter 31, respectively. Therefore, the branch passage 66 connected to the inlet 82 and the inlet 92 can be made short.

In addition, the outlet 84 and the inlet 87 can be brought close to each other by arranging the outlet 84 of the first motor water jacket 81 arranged at the lower stage at the upper portion of the first motor 11 and the inlet 87 of the second motor water jacket 86 arranged at the upper stage at the lower portion of the second motor 21. Accordingly, the motor water jacket connecting pipe 85 connecting the outlet 84 and the inlet 87 can be made short.

In addition, the outlet 94 and the inlet 97 can be brought close to each other by arranging the outlet 94 of the first inverter water jacket 91 arranged at the lower stage at the upper portion of the first inverter 31 and the inlet 97 of the second inverter water jacket 96 arranged at the upper stage at the lower portion of the second inverter 35. Accordingly, the inverter water jacket connecting pipe 95 connecting the outlet 94 and the inlet 97 can be made short.

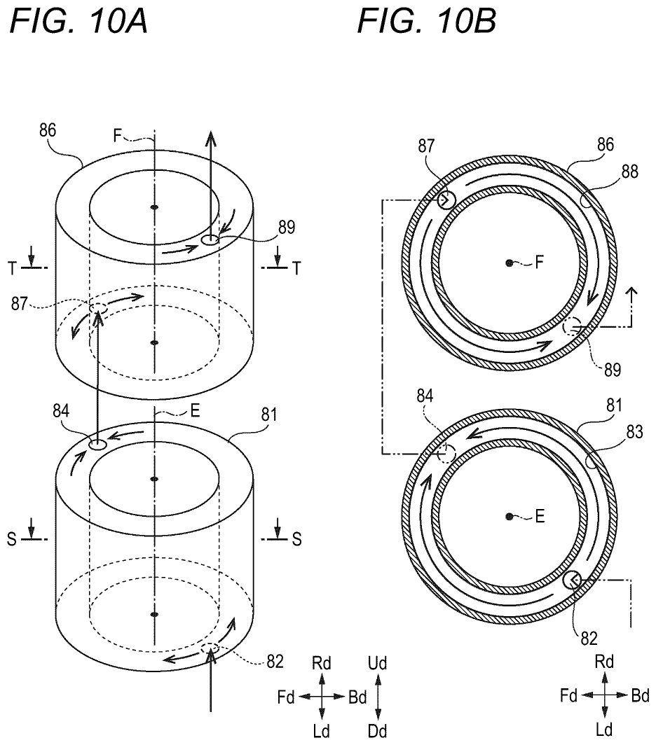

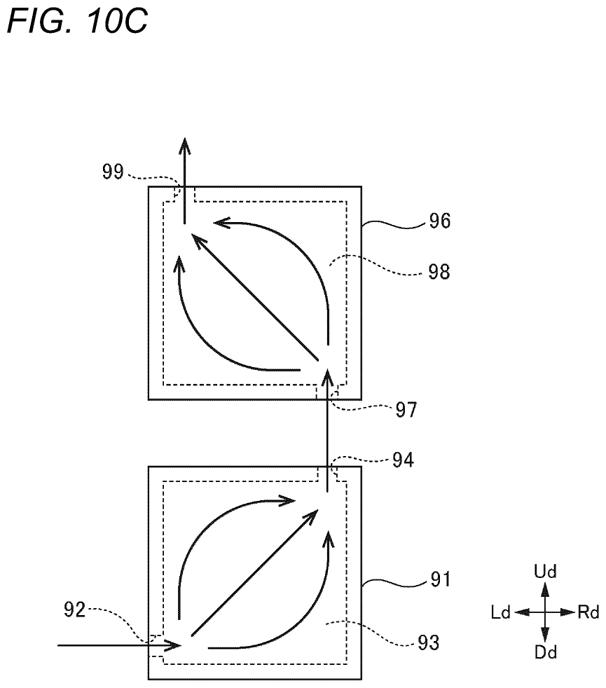

In addition, in the second motor water jacket 86 and the second inverter water jacket 96 arranged at the upper stage, the outlet 89 and the outlet 99 can be brought close to each other by arranging the outlet 89 and the outlet 99 at the upper portions of the second motor 21 and the second inverter 35, respectively. Therefore, the joint passage 101 connected to the outlet 89 and the outlet 99 can be made short.
(3) FIG. 10A schematically shows the first motor water jacket 81 and the second motor water jacket 86, which are aligned vertically, as viewed from the upper left. FIG. 10B shows cross-sectional views taken along cutting lines S-S and T-T in FIG. 10A, schematically showing each of the first motor water jacket 81 and the second motor water jacket 86, as viewed from above.

As shown in FIGS. 10A and 10B, in the cooling mechanism 61 of the outboard motor 1 of the present embodiment, the first motor water jacket 81 is provided to surround the first motor 11 on the outer periphery side of the first motor 11, and when the first motor water jacket 81 is viewed from above, the outlet 84 of the first motor water jacket 81 is arranged on a substantially opposite side to the inlet 82 of the first motor water jacket 81, across the rotation axis E (rotation center) of the first motor 11. Specifically, in the first motor water jacket 81, the inlet 82 is arranged at the left rear portion of the lower portion of the first motor 11, and the outlet 84 is arranged at the right front portion of the upper portion of the first motor 11. In addition, the second motor water jacket 86 is arranged to surround the second motor 21 on the outer periphery side of the second motor 21, and when the second motor water jacket 86 is viewed from above, the outlet 89 of the second motor water jacket 86 is arranged on a substantially opposite side to the inlet 87 of the second motor water jacket 86, across the rotation axis F (rotation center) of the second motor 21. Specifically, in the second motor water jacket 86, the inlet 87 is arranged at the right front portion of the lower portion of the second motor 21, and the outlet 89 is arranged at the left rear portion of the upper portion of the second motor 21. In addition, the first motor 11 and the second motor 21 are respectively arranged such that the outlet 84 of the first motor water jacket 81 and the inlet 87 of the second motor water jacket 86 face each other in the vertical direction. With this configuration, the entire periphery of the first motor 11 can be uniformly cooled by the first motor water jacket 81 without complicating the structure of the internal passage 83 of the first motor water jacket 81, the entire periphery of the second motor 21 can be uniformly cooled by the second motor water jacket 86 without complicating the structure of the internal passage 88 of the second motor water jacket 86, the cooling water can be smoothly delivered from the first motor water jacket 81 to the second motor water jacket 86, and the cooling efficiency for each of the first motor 11 and the second motor 21 can be enhanced by the motor water jackets 81 and 86 having generally simple configurations.

That is, the first motor water jacket 81 is arranged to surround the first motor 11 on the outer periphery side of the first motor 11, and when the first motor water jacket 81 is viewed from above, the outlet 84 of the first motor water jacket 81 is arranged on a substantially opposite side to the inlet 82 of the first motor water jacket 81 across the rotation axis E (rotation center) of the first motor 11, so that, as shown in FIG. 10B, in the internal passage 83 of the first motor water jacket 81, a counterclockwise passage length from the inlet 82 to the outlet 84 and a clockwise passage length from the inlet 82 to the outlet 84 can be made substantially the same. With this, the cooling water can be flowed uniformly over the entire periphery of the first motor 11, so that the entire periphery of the first motor 11 can be cooled uniformly. In addition, in order to flow the cooling water uniformly over the entire periphery of the first motor 11, it is not necessary to make the internal passage 83 a complex structure, such as a structure where the direction of the passage reverses at multiple points.

Similarly, the second motor water jacket 86 is arranged to surround the second motor 21 on the outer periphery side of the second motor 21, and when the second motor water jacket 86 is viewed from above, the outlet 89 of the second motor water jacket 86 is arranged on a substantially opposite side to the inlet 87 of the second motor water jacket 86 across the rotation axis F (rotation center) of the second motor 21, so that in the internal passage 88 of the second motor water jacket 86, a counterclockwise passage length from the inlet 87 to the outlet 89 and a clockwise passage length from the inlet 87 to the outlet 89 can be made substantially the same. With this, the cooling water can be flowed uniformly over the entire periphery of the second motor 21, so that the entire periphery of the second motor 21 can be cooled uniformly. In addition, in order to flow the cooling water uniformly over the entire periphery of the second motor 21, it is not necessary to make the internal passage 88 a complex structure, such as a structure where the direction of the passage reverses at multiple points.

In addition, the first motor 11 and the second motor 21 are respectively arranged so that the outlet 84 of the first motor water jacket 81 and the inlet 87 of the second motor water jacket 86 face each other in the vertical direction, allowing the motor water jacket connecting pipe 85 to be made short and straight. With this, the pressure loss of the cooling water flowing in the motor water jacket connecting pipe 85 can be reduced.
(4) FIG. 10C schematically shows the first inverter water jacket 91 and the second inverter water jacket 96, as viewed from behind. As shown in FIG. 10C, the second inverter water jacket 96 is arranged above the first inverter water jacket 91, in the first inverter water jacket 91, the inlet 92 is arranged at the lower left portion of the first inverter 31, and the outlet 94 is arranged at the upper right portion of the first inverter 31, and in the second inverter water jacket 96, the inlet 97 is arranged at the lower right portion of the second inverter 35, and the outlet 99 is arranged at the upper left portion of the second inverter 35. With this configuration, the inverter body 32 of the first inverter 31 can be uniformly cooled over a wide area by the first inverter water jacket 91 without complicating the structure of the internal passage 93 of the first inverter water jacket 91, the inverter body 36 of the second inverter 35 can be uniformly cooled over a wide area by the second motor water jacket 86 without complicating the structure of the internal passage 98 of the second inverter water jacket 96, the cooling water can be smoothly delivered from the first inverter water jacket 91 to the second inverter water jacket 96, and the cooling efficiency for each of the first inverter 31 and the second inverter 35 can be enhanced by the inverter water jackets 91 and 96 having generally simple configurations.

That is, in the first inverter water jacket 91, the inlet 92 is arranged at the lower left portion of the first inverter 31, and the outlet 94 is arranged at the upper right portion of the first inverter 31. In this way, the inlet 92 and the outlet 94 are respectively arranged at the diagonal portions of the first inverter 31. As a result, as shown in FIG. 10C, the cooling water flowing into the internal passage 93 from the inlet 92 can be easily spread throughout the internal passage 93. In addition, the cooling water spread throughout the internal passage 93 can be smoothly discharged from the outlet 94, whereby it is possible to suppress the cooling water from remaining in the internal passage 93. With this, the cooling water can be uniformly flowed over a wide area in front of the inverter body 32, so that the inverter body 32 can be uniformly cooled. In addition, in order to flow the cooling water uniformly over a wide area in front of the inverter body 32, it is not necessary to make the internal passage 93 a complex structure, such as a structure where the direction of the passage reverses at multiple points.

In addition, in the second inverter water jacket 96, the inlet 97 is arranged at the lower right portion of the second inverter 35, and the outlet 99 is arranged at the upper left portion of the second inverter 35. In this way, the inlet 97 and the outlet 99 are respectively arranged at the diagonal portions of the second inverter 35. As a result, as shown in FIG. 10C, the cooling water flowing into the internal passage 98 from the inlet 97 can be easily spread throughout the entire internal passage 98. In addition, the cooling water spread throughout the internal passage 98 can be smoothly discharged from the outlet 99, whereby it is possible to suppress the cooling water from remaining in the internal passage 98. With this, the cooling water can be uniformly flowed over a wide area in front of the inverter body 36, so that the inverter body 36 can be uniformly cooled. In addition, in order to flow the cooling water uniformly over a wide area in front of the inverter body 36, it is not necessary to make the internal passage 98 a complex structure, such as a structure where the direction of the passage reverses at multiple points.

In addition, the second inverter water jacket 96 is arranged above the first inverter water jacket 91, the outlet 94 of the first inverter water jacket 91 is arranged at the upper right portion of the first inverter 31, and the inlet 97 of the second inverter water jacket 96 is arranged at the lower right portion of the second inverter 35, so that the outlet 94 and the inlet 97 can be brought close to each other, and the inverter water jacket connecting pipe 95 connecting the outlet 94 and the inlet 97 can be made short. In addition, as shown in FIG. 10C, by arranging the outlet 94 and the inlet 97 to face each other, the inverter water jacket connecting pipe 95 can be made straight. With this, the pressure loss of the cooling water flowing in the inverter water jacket connecting pipe 95 can be reduced.
(5) In the outboard motor 1 of the present embodiment, the first inverter 31 is arranged at the rear of the first motor 11, and in the cooling mechanism 61, the inlet 82 of the first motor water jacket 81 is arranged at the left rear portion of the lower portion of the first motor 11, and the inlet 92 of the first inverter water jacket 91 is arranged at the lower left portion of the first inverter 31, so that the branch passage 66 can be made short.
(6) In the outboard motor 1 of the present embodiment, the second inverter 35 is arranged at the rear of the second motor 21, and in the cooling mechanism 61, the outlet 89 of the second motor water jacket 86 is arranged at the left rear portion of the upper portion of the second motor 21, and the outlet 99 of the second inverter water jacket 96 is arranged at the upper left portion of the second inverter 35, so that the joint passage 101 (connecting pipe 104) can be made short.
(7) In the outboard motor 1 of the present embodiment, the clutch control device 55 is arranged on the left front side between the first motor 11 and the second motor 21, and in the cooling mechanism 61, the outlet 84 of the first motor water jacket 81 is arranged at the right front portion of the upper portion of the first motor 11, the inlet 87 of the second motor water jacket 86 is arranged at the right front portion of the lower portion of the second motor 21, and the motor water jacket connecting pipe 85 is arranged on the right front side between the first motor 11 and the second motor 21. With this configuration, the clutch control device 55 and the motor water jacket connecting pipe 85 can be arranged at different locations apart from each other in the space between the first motor 11 and the second motor 21, thereby improving the assemble workability and maintainability of the outboard motor 1.
(8) The cooling mechanism 61 in the present embodiment includes the control valve 107 that controls the flow rate of cooling water after joining in the joint passage 101. The configuration of controlling the flow rate of the cooling water after joining allows for temperature regulation of the cooling water by the single control valve 107, leading to a simplified structure of the cooling mechanism 61.
(9) In the cooling mechanism 61 of the present embodiment, the cooling water is first supplied to the first motor water jacket 81, and the cooling water flowing in the first motor water jacket 81 is then supplied to the second motor water jacket 86. In this structure, the temperature of the cooling water flowing in the first motor water jacket 81 is lower than that of the cooling water flowing in the second motor water jacket 86. Therefore, the cooling capacity of the first motor water jacket 81 is higher than that of the second motor water jacket 86. For this reason, the cooling efficiency for the first motor 11 becomes higher than that of the second motor 21. Similarly, since the cooling capacity of the first inverter water jacket 91 is higher than that of the second inverter water jacket 96, the cooling efficiency for the first inverter 31 becomes higher than that of the second inverter 35. For this reason, when using the outboard motor 1, if a difference arises between the operating rates of the first motor 11 and the first inverter 31 and the operating rates of the second motor 21 and the second inverter 35, it is preferable that the operating rates of the first motor 11 and the first inverter 31 be higher than the operating rates of the second motor 21 and the second inverter 35. With this, the first motor 11 and the first inverter 31, which have higher operating rates and therefore generate more heat, are cooled more efficiently than the second motor 21 and the second inverter 35, which have lower operating rates and therefore generate less heat, and overall, the cooling efficiency for the first motor 11, the second motor 21, the first inverter 31, and the second inverter 35 can be enhanced.

In the cooling mechanism 61 of the embodiment, the arrangement of each of the branch passage 66, the inlet 82 and outlet 84 of the first motor water jacket 81, the inlet 87 and outlet 89 of the second motor water jacket 86, the inlet 92 and outlet 94 of the first inverter water jacket 91, the inlet 97 and outlet 99 of the second inverter water jacket 96, the joint passage 101, the clutch control device 55, and the like may be entirely reversed left and right.

In addition, in the cooling mechanism 61 of the embodiment, the inlets 82, 87, 92, and 97 of the four water jackets 81, 86, 91, and 96 are arranged at the lower portions of the two motors 11 and 21 and the two inverters 31 and 35, respectively, the outlets 84, 89, 94, and 99 of the four water jackets 81, 86, 91, and 96 are arranged at the upper portions of the two motors 11 and 21 and the two inverters 31 and 35, respectively, and the cooling water flows from bottom to top within each of the water jackets 81, 86, 91, and 96. However, the present disclosure is not limited thereto, and the inlets 82, 87, 92, and 97 of the four water jackets 81, 86, 91, and 96 may be arranged at the upper portions of the two motors 11 and 21 and the two inverters 31 and 35, respectively, the outlets 84, 89, 94, and 99 of the four water jackets 81, 86, 91, and 96 may be arranged at the lower portions of the two motors 11 and 21 and the two inverters 31 and 35, respectively, and the cooling water may be caused to flow from top to bottom within each of the water jackets 81, 86, 91, and 96.

In addition, in the above embodiment, each of the inverter water jackets 91 and 96 is arranged in front of the inverter body, but each of the inverter water jackets 91 and 96 may be arranged behind the inverter body, or in front of and behind the inverter body.

In addition, in the above embodiment, the water around the outboard motor 1 is introduced into the cooling mechanism 61 and used as cooling water, and the cooling water after cooling is discharged outside the outboard motor 1. However, the present disclosure is not limited thereto, and a configuration may be used in which the cooling water flows in the outboard motor, and a heat dissipation mechanism for dissipating the heat of the cooling water, such as a heat sink, is provided in the middle of the cooling water circulation path.

In addition, in the present disclosure, the power switching mechanism is not limited to that described in the above embodiment. For example, the upper end portion of the drive shaft 42 may be connected to the lower end portion of the motor shaft 12 of the first motor 11 all the time, and a power switching mechanism that switches connection and disconnection between the two motor shafts may be provided between the upper end portion of the motor shaft 12 of the first motor 11 and the lower end portion of the motor shaft 22 of the second motor 21.

In addition, the present disclosure also includes an outboard motor in which no power switching mechanism is provided and both the motor shaft of the first motor and the motor shaft of the second motor are connected to the drive shaft all the time.

In addition, the present disclosure may have a configuration with three or more motors and three or more inverters. In addition, the present disclosure can be applied to a ship propulsion machine other than the outboard motor.

In addition, the present disclosure can be changed as appropriate without departing from the scope or spirit of the disclosure which can be read from the claims and the entire specification, and the ship propulsion machine to which such a change is applied is also included in the technical spirit of the present disclosure.

What is claimed is:

1. A ship propulsion machine comprising:
a first motor;
a second motor;
a first inverter configured to generate a drive current for controlling drive of the first motor;
a second inverter configured to generate a drive current for controlling drive of the second motor;
a propeller;
a power transmission mechanism configured to transmit power of each of the first motor and the second motor to the propeller; and
a cooling mechanism configured to cool the first motor, the second motor, the first inverter, and the second inverter,
wherein the cooling mechanism comprises:
a first motor water jacket provided in the first motor and configured to cool the first motor by allowing cooling water to flow therein;
a second motor water jacket provided in the second motor and configured to cool the second motor by allowing the cooling water to flow therein;
a first inverter water jacket provided in the first inverter and configured to cool the first inverter by allowing the cooling water to flow therein;
a second inverter water jacket provided in the second inverter and configured to cool the second inverter by allowing the cooling water to flow therein;
a first cooling water passage configured to allow the cooling water to flow toward the first motor water jacket and the first inverter water jacket;
a branch passage connecting the first motor water jacket and the first inverter water jacket to the first cooling water passage such that the first motor water jacket and the first inverter water jacket are connected in parallel with each other, the branch passage being configured to distribute and supply the cooling water flowing in the first cooling water passage to the first motor water jacket and the first inverter water jacket;
a first connecting passage connecting the second motor water jacket to a downstream side of the first motor water jacket and configured to deliver the cooling water flowing in the first motor water jacket to the second motor water jacket; and
a second connecting passage connecting the second inverter water jacket to a downstream side of the first inverter water jacket and configured to deliver the cooling water flowing in the first inverter water jacket to the second inverter water jacket.

2. The ship propulsion machine according to claim 1,
wherein when a vertical direction of the ship propulsion machine is defined as an X direction and a direction perpendicular to the X direction is defined as a Y direction, the first motor is arranged such that an extension direction of a rotation axis thereof extends along the X direction, the second motor is arranged on one side of the first motor in the X direction such that an extension direction of a rotation axis thereof extends along the X direction, the first inverter is arranged on one side of the first motor in the Y direction, and the second inverter is arranged on one side of the second motor in the Y direction and on one side of the first inverter in the X direction,
wherein the first motor water jacket comprises an inlet for allowing the cooling water supplied through the branch passage to flow into the first motor water jacket, and an outlet for allowing the cooling water flowing in the first motor water jacket to flow out to an outside of the first motor water jacket,
wherein the second motor water jacket comprises an inlet for allowing the cooling water flowing out from the outlet of the first motor water jacket and delivered through the first connecting passage to flow into the second motor water jacket, and an outlet for allowing the cooling water flowing in the second motor water jacket to flow out to an outside of the second motor water jacket,
wherein the first inverter water jacket comprises an inlet for allowing the cooling water supplied through the branch passage to flow into the first inverter water jacket, and an outlet for allowing the cooling water flowing in the first inverter water jacket to flow out to an outside of the first inverter water jacket,
wherein the second inverter water jacket comprises an inlet for allowing the cooling water flowing out from the outlet of the first inverter water jacket and delivered through the second connecting passage to flow into the second inverter water jacket, and an outlet for allowing the cooling water flowing in the second inverter water jacket to flow out to an outside of the second inverter water jacket,
wherein the inlet of the first motor water jacket, the inlet of the second motor water jacket, the inlet of the first inverter water jacket, and the inlet of the second inverter water jacket are arranged at a portion on the other side of the first motor in the X direction, at a portion on the other side of the second motor in the X direction, at a portion on the other side of the first inverter in the X direction, and at a portion on the other side of the second inverter in the X direction, respectively, and
wherein the outlet of the first motor water jacket, the outlet of the second motor water jacket, the outlet of the first inverter water jacket, and the outlet of the second inverter water jacket are arranged at a portion on the one side of the first motor in the X direction, at a portion on one side of the second motor in the X direction, at a portion on the one side of the first inverter in the X direction, and at a portion on one side of the second inverter in the X direction, respectively.

3. The ship propulsion machine according to claim 2,
wherein the first motor water jacket is provided to surround the first motor on an outer periphery side of the first motor,
wherein when the first motor and the first motor water jacket are viewed from one side in the X direction, the outlet of the first motor water jacket is arranged on a substantially opposite side to the inlet of the first motor water jacket across a rotation center of the first motor,
wherein the second motor water jacket is provided to surround the second motor on an outer periphery side of the second motor,
wherein when the second motor and the second motor water jacket are viewed from one side in the X direction, the outlet of the second motor water jacket is arranged on a substantially opposite side to the inlet of the second motor water jacket across a rotation center of the second motor, and
wherein each of the first motor and the second motor are arranged such that the outlet of the first motor water jacket and the inlet of the second motor water jacket face each other in the X direction.

4. The ship propulsion machine according to claim 2,
wherein when a direction perpendicular to the X direction and the Y direction is defined as a Z direction,
the inlet of the first inverter water jacket is arranged at a portion on one side of the first inverter in the Z direction, and the outlet of the first inverter water jacket is arranged at a portion on the other side of the first inverter in the Z direction, and
the inlet of the second inverter water jacket is arranged at a portion on the other side of the second inverter in the Z direction, and the outlet of the second inverter water jacket is arranged at a portion on one side of the second inverter in the Z direction.

5. The ship propulsion machine according to claim 2, wherein the cooling mechanism comprises:
a second cooling water passage configured to allow the cooling water, which has flowed out from each of an inside of the second motor water jacket and an inside of the second inverter water jacket, to flow therein;
a joint passage connected to the outlet of the second motor water jacket, the outlet of the second inverter water jacket, and the second cooling water passage, and configured to join the cooling water flowing out from the outlet of the second motor water jacket with the cooling water flowing out from the outlet of the second inverter water jacket and to allow the joined cooling water to flow into the second cooling water passage; and
a valve configured to control a flow rate of the cooling water after joining in the joint passage.
